(19) United States
(12) Patent Application Publication
(10) Pub. No.: US 2024/0390765 A1
(43) Pub. Date: Nov. 28, 2024

(54) SYSTEM FOR COLLECTING TELEMETRY DATA FROM A FLYING DISC

(71) Applicant: TechDisc Inc., Overland Park, KS (US)

(72) Inventors: John Antonio Carrino, Redwood City, CA (US); Michael Anthony Sizemore, Overland Park, KS (US)

(73) Assignee: TechDisc Inc., Overland Park, KS (US)

(21) Appl. No.: 18/671,621

(22) Filed: May 22, 2024

Related U.S. Application Data
(60) Provisional application No. 63/468,258, filed on May 22, 2023.

(51) Int. Cl. A63B 71/06; A63H 33/18; H04W 4/38

(52) U.S. Cl. CPC A63B 71/0619; A63H 33/18; H04W 4/38; A63B 2071/0647; A63B 2220/35; A63B 2220/40; A63B 2220/806; A63B 2220/808; A63B 2220/89

(57) ABSTRACT

Implementations described and claimed herein describe methods and systems for collecting and processing telemetry data from a flying disc. The flying disc includes at least one sensor, and the flying disc system is configured to establish a wireless connection between the communications system and a computing device, transmit sensor data from the at least one sensor to an application operating on the computing device, and cause a display of the computing device to display a user interface depicting launch parameters and/or a simulated flight path of the throw.

### CROSS REFERENCE TO RELATED APPLICATIONS

This patent application claims the benefit of and priority to U.S. Provisional Patent Application No. 63/468,258 titled “SYSTEM FOR COLLECTING TELEMETRY DATA FROM A FLYING DISC,” and filed May 22, 2023, the content of which is hereby incorporated herein by reference in its entirety for all purposes.

### FIELD

Aspects of the present disclosure relate generally to flying discs used in disc sports, and more particularly, flying discs which collect telemetry data while in flight.

### BACKGROUND

Sports involving the use of flying discs have grown in popularity in recent years, with many disc sports reaching professional status, where participants enter contests that reward winners with monetary compensation. Consequently, participants and other enthusiasts of disc sports often seek ways to improve themselves and others. The advent of modern electronics and communications technologies now permit the mounting of electronic sensors onboard a flying disc without substantially impacting its flight in order to obtain telemetry data of the disc in flight as well as motion tracking information about an athlete's motions that lead up to the flight.

Currently available telemetry enabled discs focus on a flight portion only. However, insight from the form exhibited by the thrower, from the wind up to the point of release provides the thrower with much more detailed information. Further, providing analysis of the wind up prior to the release helps the thrower to determine what adjustments can be made to the form of the launch in order to improve the flight.

Therefore, a need exists to overcome the problems with the prior art as discussed above, and particularly for collecting data from a disc which may allow a user to improve their technique. It is with these observations in mind, among others, that various aspects of the present disclosure were conceived and developed.

### SUMMARY

Implementations described and claimed herein address the foregoing problems by providing a telemetry enabled flying disc system. Other implementations are also described and recited herein. Further, while multiple implementations are disclosed, still other implementations of the presently disclosed technology will become apparent to those skilled in the art from the following description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

In one implementation, a method for processing telemetry data of a flying disc is described. The method includes establishing a wireless connection between an electronics package of the flying disc and a computing device, the electronics package including at least one sensor and a communications system. The method further includes receiving sensor data of a throw from the electronics package of the flying disc via the wireless connection, wherein the sensor data is collected by the at least one sensor of the flying disc and identifying a release point of the flying disc by analyzing the sensor data. The method further includes calculating, using sensor data collected over a predetermined period after the release point, at least one launch parameter of the throw and displaying, via a user interface on a display of the computing device, the at least one launch parameter of the throw.

In another implementation, a telemetry enabled flying disc system is described. The system includes a flying disc including an electronics package mounted to the flying disc, the electronics package including at least one processor, at least one memory, at least one sensor, and a communications system. The telemetry enabled flying disc system is configured to store and execute instructions stored in the at least one memory that cause the at least one processor to establish a wireless connection between the communications system and a computing device, transmit, via the wireless connection, sensor data from the at least one sensor to an application operating on the computing device, wherein transmitting the sensor data causes the application to analyze the data to identify a release point of a throw of the flying disc, and cause a display of the computing device to display a user interface depicting at least one launch parameter of the throw, wherein the at least one launch parameter is calculated using sensor data collected over a predetermined period after the release point.

In yet another implementation, a telemetry enabled flying disc system is described. The system includes a flying disc including an electronics package mounted to the flying disc, the electronics package including at least one processor, at least one memory, at least one sensor, and a communications system. The telemetry enabled flying disc system is configured to store and execute instructions stored in the at least one memory that cause the at least one processor to detect movement of the flying disc indicative of a throw, collect sensor data from the at least one sensor, transmit, via a wireless connection, sensor data from the at least one sensor to an application operating on a computing device, wherein transmitting the sensor data causes the application to analyze the data to identify a release point of a throw of the flying disc, cause a display of the computing device to display a user interface depicting at least one launch parameter of the throw, wherein the at least one launch parameter is calculated using sensor data collected over a predetermined period after the release point, and cause the user interface to display a simulated flight path of the throw, wherein the simulated flight path is simulated based upon the at least one launch parameter of the throw.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

The patent or application file contains at least one drawing executed in color. Copies of this patent or patent application publication with color drawing(s) will be provided by the Office upon request and payment of the necessary fec.

FIG. 1 depicts an exemplary system including a flying disc.

FIG. 2 depicts the flying disc.

FIG. 3 depicts a schematic view of the electronics package with the housing removed.

FIG. 4 depicts an alternate arrangement of the sensors of the flying disc.

FIG. 5 depicts an example of location and velocity data that can be sensed and measured for pre-launch and launch stages as well as the simulated flight of the disc after the launch.

FIGS. 6A-6F depict examples of the user interfaces which may be displayed.

FIG. 7 depicts example operations for collecting telematics data from a flying disc.

FIG. 8 depicts an example of a computing system having one or more computing units that may implement various systems and methods.

### DETAILED DESCRIPTION

The following detailed description refers to the accompanying drawings. Wherever possible, the same reference numbers are used in the drawings and the following description to refer to the same or similar elements. While examples of the claimed subject matter may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the claimed subject matter. Instead, the proper scope of the claimed subject matter is defined by the appended claims.

The Figures show various examples of collecting and analyzing data obtained by a flying disc. As defined herein, the term “flying disc” refers to a disc or frisbee which is thrown as part of any number of sports, including, but not limited to disc golf, ultimate frisbee, and discus throw. The claimed subject matter improves over the prior art by providing a telematics enabled flying disc which configured to collect data before, during, and after the disc is thrown. The telematics enabled flying disc collects data using at least one sensor and transmits the data to an application running on a user computing device. The application analyzes the data and generates a simulated flight path corresponding to the throw. In some instances, the analysis identifies distinct stages of the throw: pre-launch, launch, and flight. Pre-launch includes the preparation and wind up prior to the release. The launch includes the moments just before and after the release. The flight includes the trajectory of the flying disc once it is released by the thrower. In some instances, the application can simulate a flight based upon the sensor data obtained prior to a release point, or the moment the thrower lets go of the flying disc. The application can display a variety of characteristics of the launch and flight. In some instances, one or more of the characteristics can be adjusted in the user interface by the user and a modified flight path can be modeled and displayed by the application. This allows the user to evaluate the impact of tweaks in their form may have on the flight. In some examples, the telematics enabled flying disc is integrated into a simulator environment, wherein the flight is simulated in real time on a screen ahead of the thrower. The functionality and structures of the presently disclosed technology will be understood from the drawings and the example, non-limiting claims that follow.

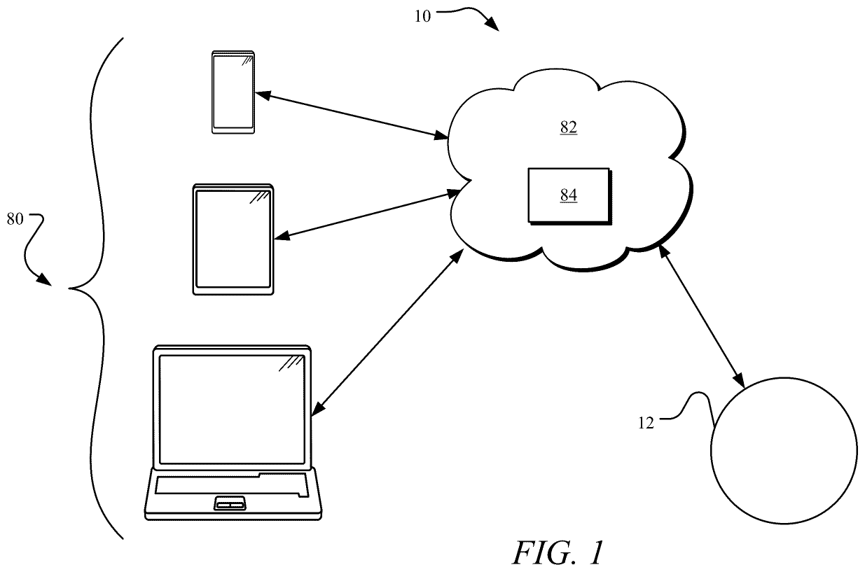

To begin a detailed description, FIG. 1 depicts an exemplary system 10 including the flying disc 12, a computing device 80, a network 82, and an application 84. The computing device 80 may be a mobile device, tablet, laptop, or any other suitable computing device. The computing device 80 may have local data storage and one or more non-transitory computer-readable media. The computing device 80 may be in communication with remote data storage and network 82, sometimes referred to as cloud services. The application 84 is depicted as being located within the network, however, in some examples, the application 84, may be stored on the computing device 80. The flying disc 12 includes an electronics package which will be discussed in further detail below. The electronics package includes a communications module capable of sending and receiving data. In some instances, the electronics package may send or receive data via the network 82. In other instances, a connection may be established between the electronics package and the mobile device 80 via a near-field wireless communication protocol, Wi-Fi, Bluetooth®, or any other suitable wireless communication protocol.

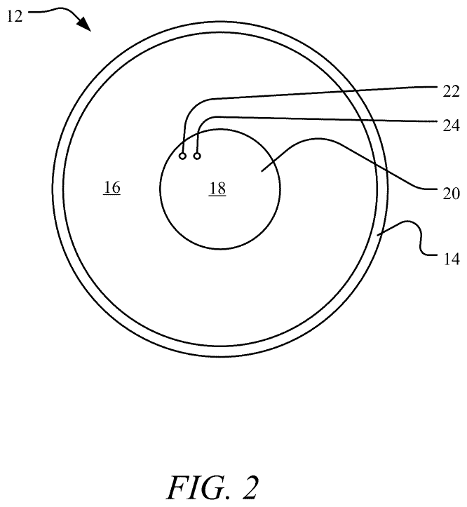

FIG. 2 depicts the flying disc 12 having a rim 14 and a flight plate 16. Other than typically having an overall circular shape, the particular size, shape, and aspect ratios of the disc rim and flight plate may vary from one disc to another. An electronics package 18 is mounted to the underside of the disc at or near the center of the disc and has a housing 20, a switch 22, and LED light 24. The electronics package 18 includes a communications module which allows the electronics package 18 to establish a connection with the computing device 80. The computing device 80 may include an application which receives and analyzes data generated by the electronics package 18.

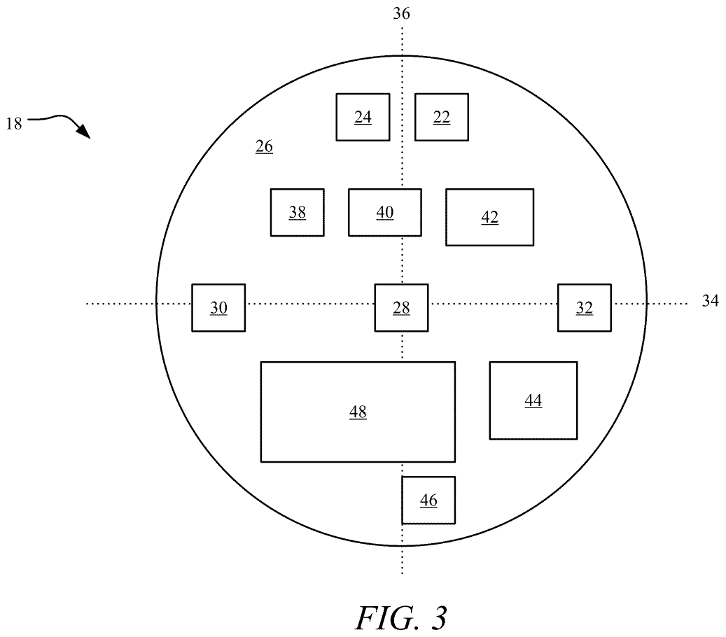

FIG. 3 shows a schematic view of the electronics package 18 with the housing removed. The electronics package 18 has as a substrate a printed circuit board (“PCB”) 26. A plurality of sensors and components are mounted on the PCB 26. FIG. 3 depicts an exemplary layout, but in other examples, other components may be arranged into a different layout. A first sensor 28 is mounted at or near the center of the PCB 26, which in turn is at or near the center of the electronics package 18. A second sensor 30 and a third sensor 32 are mounted at the periphery of the PCB 26 along a first axis 34 with first sensor 28 and symmetric about a second axis 36 orthogonal to first axis 36. Sensors 28, 30, and 32 may be electro-mechanical capacitance accelerometers or other electro-mechanical sensors designed to measure dynamic forces acting on the disc 12. In some examples, sensor 28 is sufficient alone to measure the relevant dynamic forces acting on the disc 12. Alternatively, sensors 30 and 32 in combination can measure the relevant dynamic forces acting on the disc 12. The use of sensor 28 alone or sensors 30 and 32 in combination provides two independent options to measure relevant data, and they may also be used together to provide enhanced or corroborated data. A fourth sensor 38 may be a sensor of a different type such as a gyroscope, magnetometer, barometer, camera, timer, radar device, or microphone to be used to capture additional data. Each sensor 28, 30, 32, and 38 may have different maximum limits, noise, accuracy, and power consumption characteristics. Particular characteristics of the sensors 28, 30, 32, and 38 may be selected to take advantage of particular positions on the disc 12 or electronics package 18 in order to appropriately measure desired parameters. In other examples, any suitable number of sensors may be used to collect data.

The electronics package 18 further includes a battery 40, power supply circuitry 42, and a charging port 44 to facilitate the use of a rechargeable battery. The power supply circuitry 42 includes switch 22, which enables the electronics package 18 to be turned on and off. However, the electronics package 18 also includes a low-power mode such that when all sensors have been idle for a predetermined amount of time, the power supply circuitry 42 will place the electronics package 18 in low-power mode to conserve battery life. In some examples, the switch may be a simple maintained on/off switch. In other examples, the switch 22 may be a momentary switch. In other examples, the momentary switch may provide additional functionality by distinguishing between the duration or repetition of various switch presses.

A fifth sensor 46 is a low power sensor dedicated to detecting wake-up events such that when the disc 12 has been idle and in low-power mode is then moved in a way indicative of relevant use, the fifth sensor 46 will trigger the power supply circuitry 42 to switch to an active mode to permit full use of all relevant components of the electronics package 18. The LED light 24, visible through an aperture in the housing 20, is used to indicate that the power supply circuitry 42 and electronics package 18 are in an active mode, among other possible uses for the LED light 24. In addition, sensors 28, 30, 32, 38, and 46 may be optimized to dynamically scale measurement rates and usage based upon levels of motion detected in order to minimize or optimize power consumption.

The electronics package 18 has an integrated circuit 48 that contains transitory and non-transitory memory, wireless or near-field communications circuitry, antenna, and a processor. In an alternative embodiment, a separate antenna such as a copper trace antenna in an inverted F pattern may be used. Firmware or other computer-readable instructions reside on the integrated circuit 48 to coordinate the collection and transmission of data from the various sensors 28, 30, 32, 38, and 46 to the computing device 80 when a relevant event is detected by the sensors. In particular, it is useful to detect and segment particular motions of the disc 12 indicative of particular phases of a throw, such as the run up, reach back, swing, in-air flight, and groundplay. This data segmentation may be helpful for prioritization of data transfer and processing.

The use of the PCB 26 permits the electronics package 18 to occupy a relatively small footprint and mass relative to the size and mass of the disc 12, which in turn means that when mounted to the disc 12, the electronics package 18 has a negligible impact on the overall flight of the disc 12. The particular layout of the PCB 26 as illustrated in FIG. 3 is not critical to the overall performance of the electronics package 18, however it may be desirable to lay out components in such a way that the center of mass of the PCB 26 and electronics package 18 is at or near the geometric center of the electronics package 18 or the disc 12 in order to minimize any undesired effects upon the flight of the disc 12. In some alternative examples, it is possible to use wires, solder, conductive ribbon or tape, fiber optics, or other means to connect the various components found in the electronics package 18 to create alternative layouts of the various components without a printed circuit board.

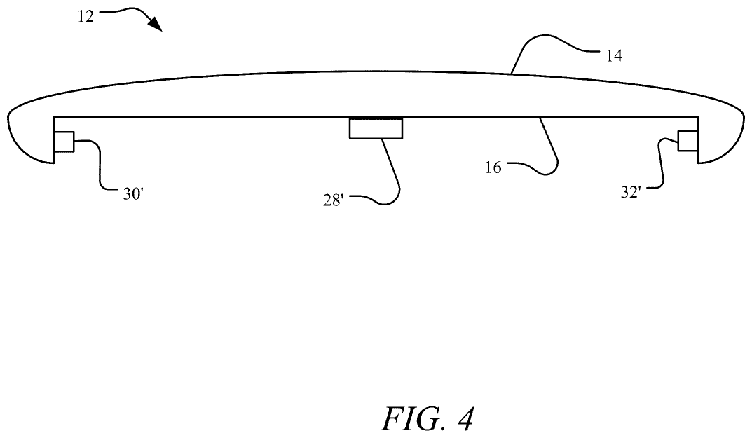

In one such example, partially illustrated in FIG. 4, first sensor 28′ may be mounted at the center of the disc flight plate 16, and second and third sensors 30′ and 32′ may be mounted near the rim 14 of the disc in such a way that the second and third sensors 30′ and 32′ are not coplanar with the first sensor 28′ on the flight plate 16. In this example, other components from the electronics package 18 may be mounted or embedded elsewhere on the disc 12 and wires or other conductors connecting the components may be embedded in the disc 12.

Prior to use for data collection, the integrated circuit 48 should be paired via a conventional near-field wireless communication protocol or Bluetooth® to the computing device 80. The computing device 80 may host non-transitory computer-readable media designed to interface with non-transitory computer-readable media residing on the integrated circuit 48 to facilitate transmission of relevant data gathered from sensors 28, 30, 32, 38, and 46 to the computing device 80 and further to the network 82. As is conventionally known, non-transitory computer-readable media on the computing device 80 may be a dedicated software program such as a software application 84 designed with a graphical or other human user interface to facilitate the control of the integrated circuit 48, power supply circuitry 42, data collection from the sensors 28, 30, 32, 38, and 46, and transmission and storage of relevant data to and from network 82.

As previously mentioned, it is useful to detect and segment particular motions of the disc 12 indicative of particular phases of a throw, such as the run up, reach back, swing, in-air flight, and groundplay. In some examples, the switch 22 may be used to cue relevant software instructions residing on the integrated circuit 48 that a throw to be measured is imminent. Alternatively, relevant software or circuitry may monitor any or all of sensors 28, 30, 32, 38, and 46 to detect particular motions that indicate that a throw is imminent and to disregard motions consistent with non-throwing disc motions, such as general handling, moving a disc in and out of a storage or carrying bag, or transporting a disc on foot or in a vehicle. Data from sensors 28, 30, 32, 38, and 46 may be continually monitored and stored on a rolling basis to volatile storage or memory on or connected to the integrated circuit 48 so that in the event a throw or other relevant event is detected, data prior to the event may be transmitted to the computing device 80 and persisted via the software application 84.

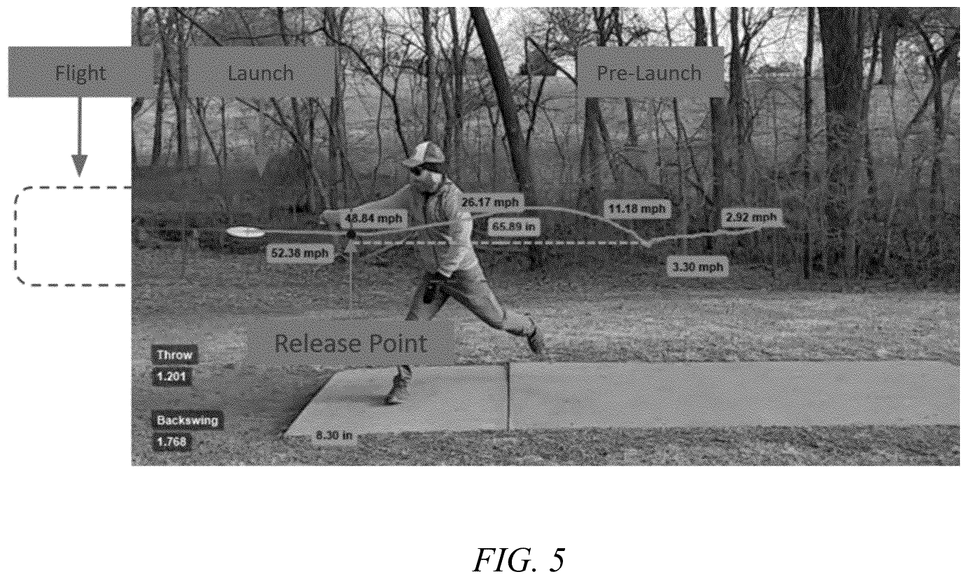

FIG. 5 provides an example of location and velocity data that can be sensed and measured for different stages of a throw. As used herein, “throw” describes the entire sequence from picking up the disc through the disc landing after the flight. Further, as used herein, “pre-launch” is used to describe the motion of the disc prior to the release point, and “launch” is used to describe the period immediately following the release point. Once sensor data of a throw, including pre-launch and launch, is collected, numerous manipulations can be made via the software application 84, including computing the overall motion of the disc, which motion can be extrapolated to a simulated full flight of the disc in virtual three-dimensional space as well as projected onto any 2D plane. These flight paths and projections can be modeled and displayed on appropriate interfaces on a computing device 80 or other remote computer that accesses the network 82.

Pre-launch data may be collected from the time initial movement of the disc 12 is detected up until a release point. The release point defines the moment that the disc 12 is released by the thrower, which may be identified by data from sensors 28, 30, 32, 38, and 46 indicating that the disc is rotating. Because the disc 12 does not rotate until the thrower releases, the rotation is indicative that the thrower has released the disc 12. Launch data is collected after the release point and within the first moments (e.g., less than 20 milliseconds), or the first few rotations of the disc. Flight data is then extrapolated from the collected data to model the flight path.

The pre-launch data provides insight relating to a thrower's address of the disc prior to commencing a throw, the run up, reach back, and swing. Once a release is detected, the sensors 28, 30, 32, 38, and 46 collect data sufficient for the software application 84 to compute metrics that describe and quantify characteristics of the throw. Such metrics may include the velocity of the disc, the spin of the disc, off-axis torque (or wobble) acting on the disc, the launch angle of the disc, the nose angle of the disc, and the hyzer angle of the disc. Additionally, the software application 84 may be configured to process sensor data to compute the position and orientation of a disc in flight in 3D space, known as quaternions.

Although a user may throw a disc in open air, the limitations of conventional near-field wireless communications and power limitations imposed by the size and mass of the electronics package 18 suggest that the communication connection between the integrated circuit 48 and the computing device 80 is likely to be lost after the disc travels some distance, a distance likely less than the total distance of the full flight of the disc in open air. Consequently, sensor data subsequent to the first few moments of flight is often unavailable for real-time transmission to the computing device 80 unless a means for storing the data locally on the integrated circuit 48 is provided. Nevertheless, full flight data can be projected based upon data recorded from the first few feet of flight. In some environments it is useful to throw a disc with the electronics package 18 into a net for easy retrieval and rapid subsequent throws. In such environments, it may be desirable to capture only the first few feet of the disc's flight and calculate the disc's full flight from such initial flight path data. In some examples, sensor data is only collected for only a handful of complete rotations of the disc, or for about 10-20 milliseconds.

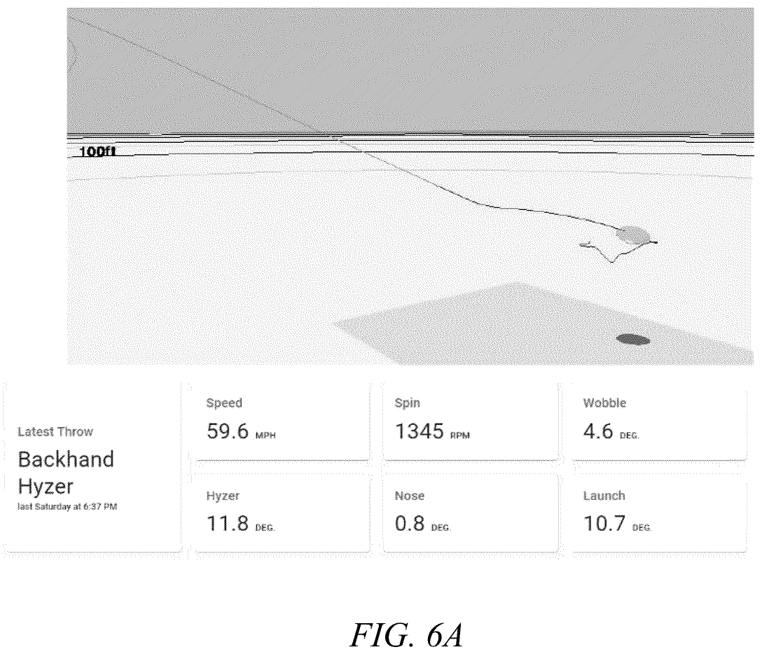

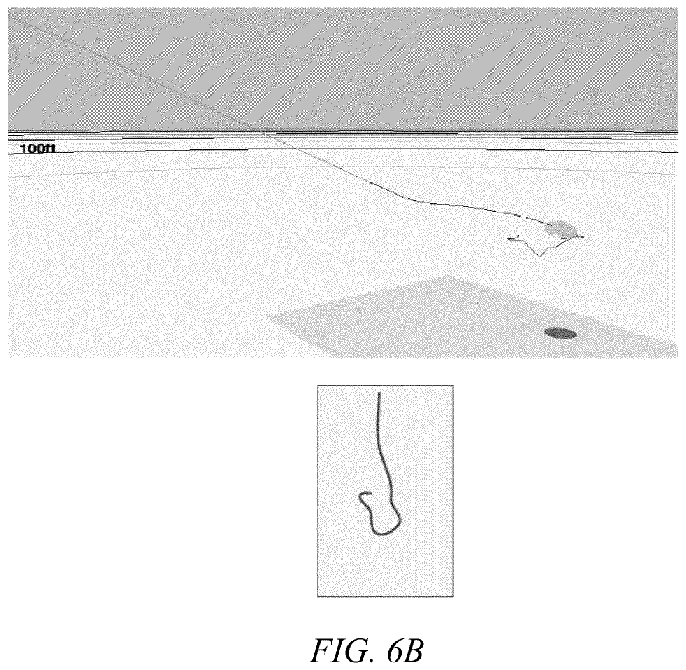

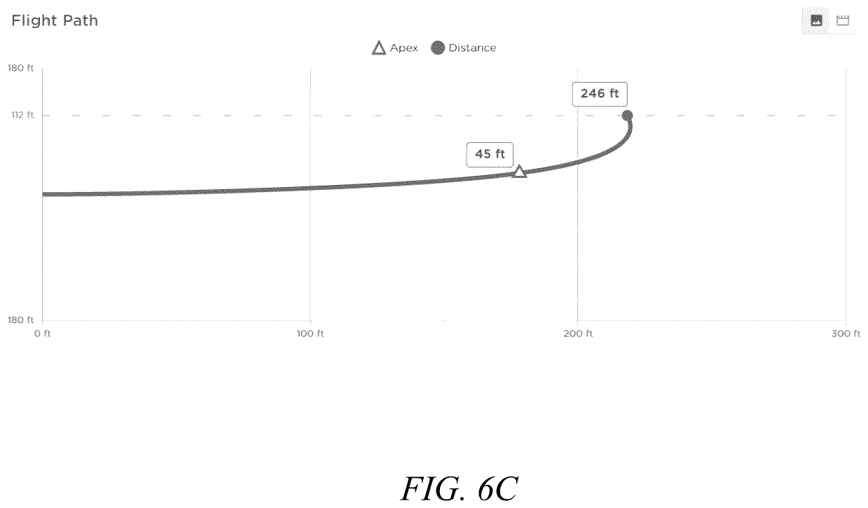

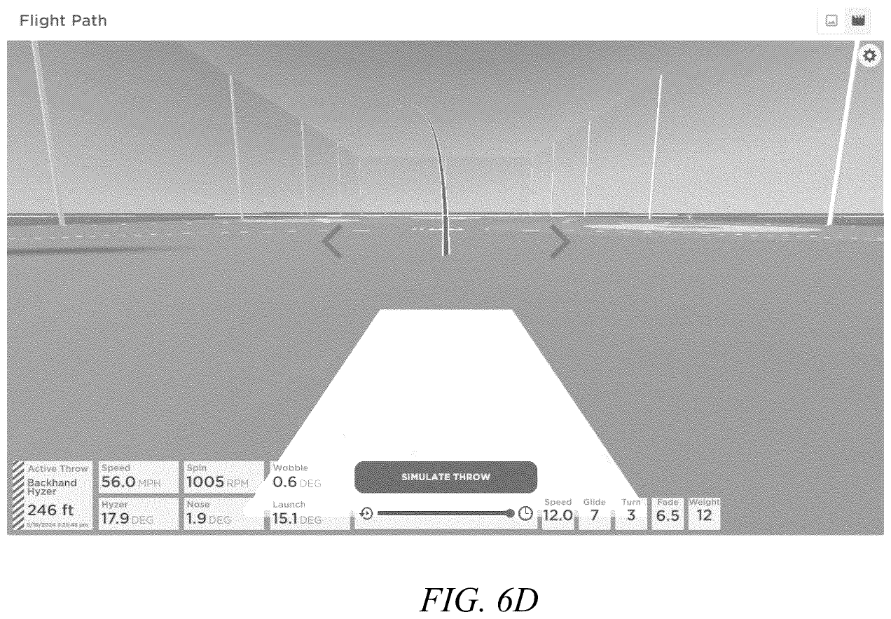

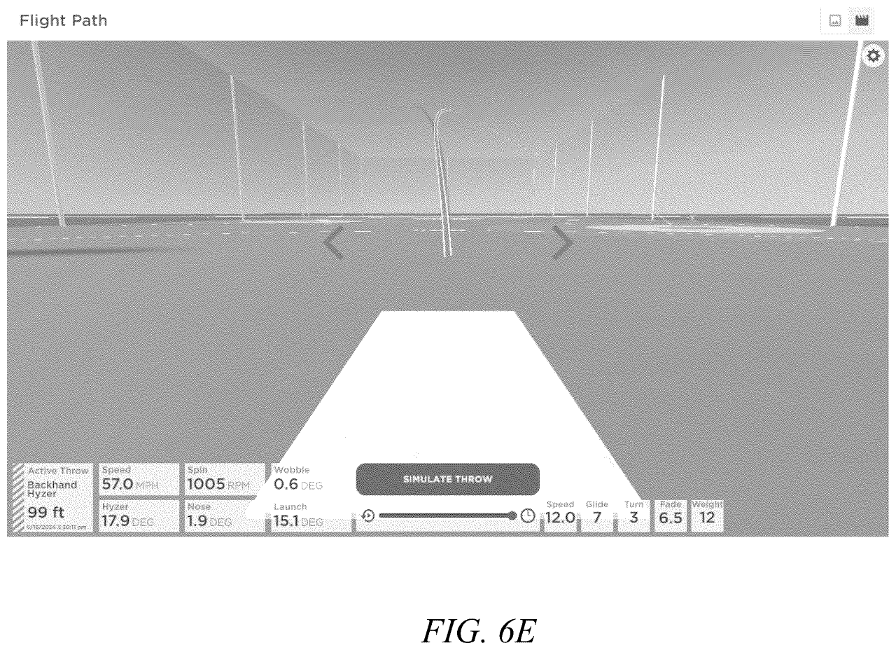

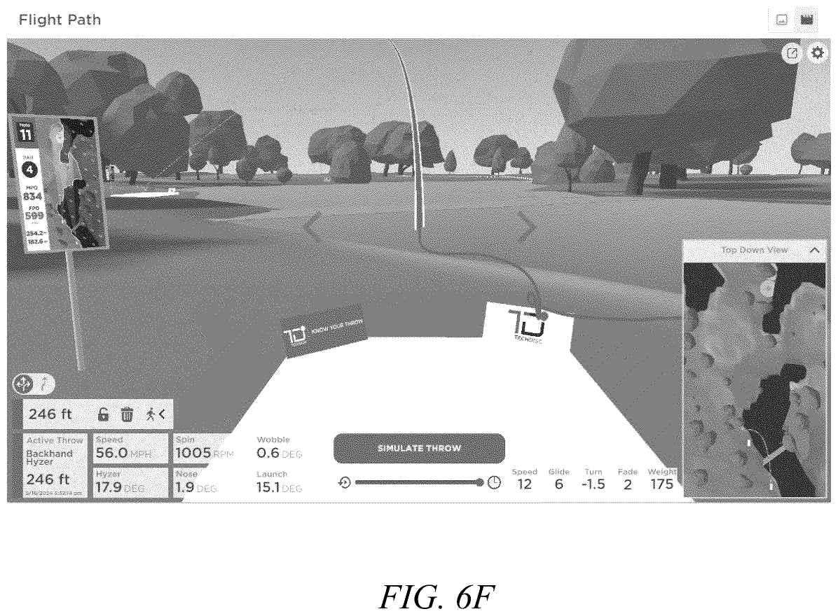

FIGS. 6A-6F depict various arrangements of the user interface which may be displayed. FIG. 6A shows an example of a three-dimensional display of both measured launch data and simulated full flight data of a disc, along with an example display of such measured launch data as speed, spin, wobble, hyzer angle, nose angle, and launch angle. FIG. 6B further shows a two-dimensional projection into a horizontal plane of the same measured launch data. FIG. 6C depicts a 2D representation of a flight path.

In addition to projecting a simulated full flight of the disc, both measured and extrapolated data can be further modified to simulate changed variables such as changed flight characteristics of the disc (speed, glide, turn, and fade) or changing any of the actual measured launch data. For example, a user may want to see a simulated flight of a throw if any of the launch angle, nose angle, or hyzer angle were increased or decreased. In this way, a user could use simulated and modified flight data to optimize his or her throw, presuming that it may be more difficult to modify the speed, spin, and wobble of any given throw, without needing to make repeated throws of the disc. The user can optimize a throw through simulation and then focus on executing a lesser number of practice throws to practice matching the optimized launch characteristics of the optimized throw. FIG. 6D depicts an example of an original flight path. In FIG. 6E, the speed is adjusted from 56 mph to 57 mph, and a new flight path is generated and superimposed over the original flight path.

FIG. 6F depicts another example of a user interface that may be presented to depict a flight path. Notably, the user interface includes the flight path from a first-person view. Any number of backgrounds may be used. In this instance a background of a real disc golf hole is depicted. The user interface also presents a top view of the throw. Any of FIGS. 6A-6F may also include an animation of the flying disc along the flight path.

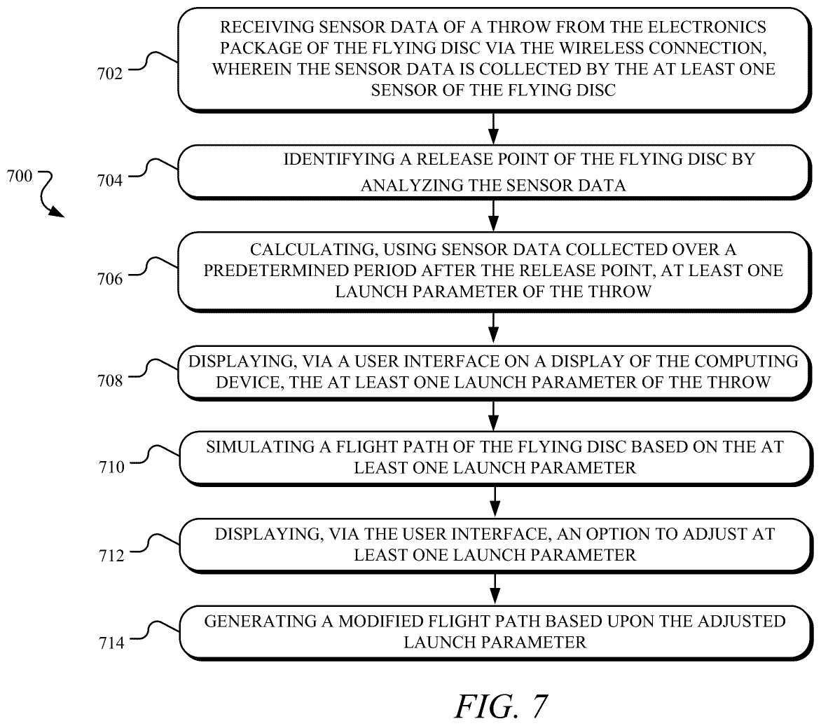

FIG. 7 depicts example operations 700 for collecting telematics data from a flying disc are illustrated. In one implementation, an operation 702 includes receiving sensor data of a throw from the electronics package of the flying disc via the wireless connection, wherein the sensor data is collected by the at least one sensor of the flying disc. An operation 704 includes identifying a release point of the flying disc by analyzing the sensor data. An operation 706 includes calculating, using sensor data collected over a predetermined period after the release point, at least one launch parameter of the throw. An operation 708 includes displaying, via a user interface on a display of the computing device, the at least one launch parameter of the throw. An operation 710 includes simulating a flight path of the flying disc based on the at least one launch parameter. An operation 712 includes displaying, via the user interface, an option to adjust at least one launch parameter. Finally, an operation 714 includes generating a modified flight path based upon the adjusted launch parameter.

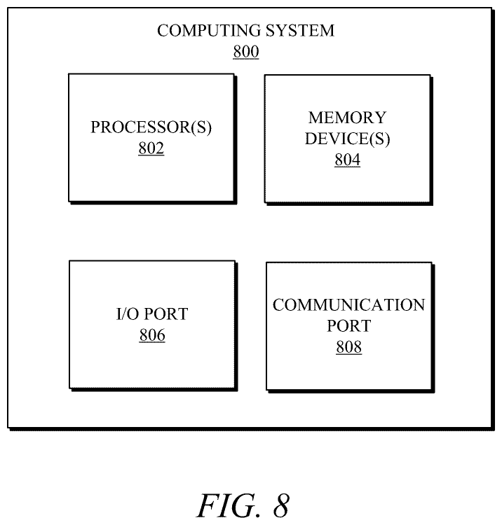

FIG. 8 shows an example of a computing system 800 having one or more computing units that may implement various systems and methods discussed herein is provided. The computing system 800 may be used to implement the computing device 80. It will be appreciated that specific implementations of these devices may be of differing possible specific computing architectures not all of which are specifically discussed herein but will be understood by those of ordinary skill in the art.

The computing system 800 may be capable of executing a computer program product and/or a computer process. Data and program files may be input to the computing system 800, which reads the files and executes the programs therein. For instance, the computing system 800 can store one or more applications that receive various inputs (e.g., the sensor data) and execute multiple algorithmic steps (e.g., as discussed herein), to generate the simulated flight path.

Some of the elements of the computing system 800 are shown in FIG. 8, including one or more hardware processors 802, one or more data storage devices 804, such as memory devices, and/or one or more ports 806 or 808. Additionally, other elements that will be recognized by those skilled in the art may be included in the computing system 800 but are not explicitly depicted in FIG. 8 or discussed further herein. Various elements of the computing system 800 may communicate with one another by way of one or more communication buses, point-to-point communication paths, or other communication means not explicitly depicted in FIG. 8.

The processor 802 may include, for example, a central processing unit (CPU), a microprocessor, a microcontroller, a digital signal processor (DSP), and/or one or more internal levels of cache. There may be one or more processors 802, such that the processor 802 comprises a single central-processing unit, or a plurality of processing units capable of executing instructions and performing operations in parallel with each other, commonly referred to as a parallel processing environment.

The computing system 800 may be a standalone computer, a distributed computer, or any other type of computer, such as one or more external computers made available via a cloud computing architecture. The presently described technology is optionally implemented in software stored on the data storage device(s) 804, (e.g., memory device(s)), and/or communicated via one or more of the ports 806 or 808, thereby transforming the computing system 800 in FIG. 8 to a special purpose machine for implementing the operations described herein. Examples of the computing system 800 include personal computers, terminals, workstations, mobile phones, tablets, laptops, personal computers, multimedia consoles, gaming consoles, set top boxes, and the like.

The one or more data storage devices 804 may include any non-volatile data storage device capable of storing data generated or employed within the computing system 800, such as computer executable instructions for performing a computer process, which may include instructions of both application programs and an operating system (OS) that manages the various components of the computing system 800. The data storage devices 804 may include, without limitation, magnetic disk drives, optical disk drives, solid state drives (SSDs), flash drives, and the like. The data storage devices 804 may include one or more memory devices such as removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices can include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in the data storage devices 804, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures. The machine-readable media may store instructions that, when executed by the processor, cause the systems to perform the operations disclosed herein.

In some implementations, the computing system 800 includes one or more ports, such as an input/output (I/O) port 806 and a communication port 808, for communicating with other computing, network, or reservoir development devices. It will be appreciated that the ports 806 and 808 may be combined or separate and that more or fewer ports may be included in the computing system 800.

The I/O port 806 may be connected to an I/O device, or other device, by which information is input to or output from the computing system 800. Such I/O devices may include, without limitation, one or more input devices, output devices, and/or environment transducer devices.

In some implementations, the input devices convert a human-generated signal, such as, human voice, physical movement, physical touch or pressure, and/or the like, into electrical signals as input data into the computing system 800 via the I/O port 806. Similarly, the output devices may convert electrical signals received from computing system 800 via the I/O port 806 into signals that may be sensed as output by a human, such as sound, light, and/or touch. The input device may be an alphanumeric input device, including alphanumeric and other keys for communicating information and/or command selections to the processor 802 via the I/O port 806. The input device may be another type of user input device including, but not limited to: direction and selection control devices, such as a mouse, a trackball, cursor direction keys, a joystick, and/or a wheel; one or more sensors, such as a camera, a microphone, a positional sensor, an orientation sensor, a gravitational sensor, an inertial sensor, and/or an accelerometer; and/or a touch-sensitive display screen (“touchscreen”). The output devices may include, without limitation, a display, a touchscreen, a speaker, a tactile and/or haptic output device, and/or the like. In some implementations, the input device and the output device may be the same device, for example, in the case of a touchscreen. Furthermore, the input devices and/or output devices can include a user interface (UI), for instance, to present the simulated flight path.

In some implementations, a communication port 808 is connected to a network (e.g., the network 82) by way of which the computing system 800 may receive network data useful in executing the methods and systems set out herein as well as transmitting information and network configuration changes determined thereby. Stated differently, the communication port 808 connects the computing system 800 to one or more communication interface devices configured to transmit and/or receive information between the computing system 800 and other devices by way of one or more wired or wireless communication networks or connections. Examples of such networks or connections include, without limitation, Universal Serial Bus (USB), Ethernet, Wi-Fi, Bluetooth®, Near Field Communication (NFC), Long-Term Evolution (LTE), and so on. One or more such communication interface devices may be utilized via the communication port 808 to communicate one or more other machines, either directly over a point-to-point communication path, over a wide area network (WAN) (e.g., the Internet), over a local area network (LAN), over a cellular (e.g., third generation (3G) or fourth generation (4G) or fifth generation (5G) network), or over another communication means. Further, the communication port 808 may communicate with an antenna or other link for electromagnetic signal transmission and/or reception.

The computing system 800 set forth in FIG. 8 is but one possible example of a computer system that may employ or be configured in accordance with aspects of the present disclosure. It will be appreciated that other non-transitory tangible computer-readable storage media storing computer-executable instructions for implementing the presently disclosed technology on a computing system may be used. In the present disclosure, the methods and operations disclosed herein may be implemented as sets of instructions or software readable by a device. These sets of instructions can convert the computing system 800 into a special purpose device for generating the simulated flight paths (e.g., a new type of file). As such, the computing system 800 is integrated into a practical application by providing improved simulations of flight paths.

The instructions, media for conveying such instructions, computing resources for executing them, and other structures for supporting such computing resources can be means for providing the functions described in these disclosures.

In the present disclosure, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order and are not necessarily meant to be limited to the specific order or hierarchy presented.

While the present disclosure has been described with reference to various implementations, it will be understood that these implementations are illustrative and that the scope of the present disclosure is not limited to them. Many variations, modifications, additions, and improvements are possible. More generally, examples in accordance with the present disclosure have been described in the context of particular implementations. Functionality may be separated or combined in blocks differently in various examples of the disclosure or described with different terminology. These and other variations, modifications, additions, and improvements may fall within the scope of the disclosure as defined in the claims that follow.

1. A method for processing telemetry data of a flying disc, the method comprising:
establishing a wireless connection between an electronics package of the flying disc and a computing device, the electronics package including at least one sensor and a communications system;
receiving sensor data of a throw from the electronics package of the flying disc via the wireless connection, wherein the sensor data is collected by the at least one sensor of the flying disc;
identifying a release point of the flying disc by analyzing the sensor data;
calculating, using sensor data collected over a predetermined period after the release point, at least one launch parameter of the throw; and
displaying, via a user interface on a display of the computing device, the at least one launch parameter of the throw.

2. The method of claim 1, further comprising:
simulating a flight path of the flying disc based on the at least one launch parameter;
wherein displaying, via the display of the computing device, the at least one launch parameter of the throw, further comprises displaying the flight path.

3. The method of claim 2, further comprising:
displaying, via the user interface, an option to adjust at least one launch parameter; and
generating a modified flight path based upon the adjusted launch parameter.

4. The method of claim 1, further comprising:
displaying, via the user interface a pre-launch path of the flying disc.

5. The method of claim 2 wherein the user interface comprises an animation depicting the flight path of the throw.

6. The method of claim 2, wherein the flight path is displayed in a two-dimensional or a three-dimensional view.

7. The method of claim 1 wherein the release point is determined by identifying a rotation of the flying disc by analyzing the sensor data.

8. The method of claim 1 wherein the predetermined period is a range of about 10-20 milliseconds.

9. The method of claim 1 wherein the at least one sensor is one of an accelerometer, a gyroscope, a magnetometer, a barometer, a camera, a timer, a radar device, or a microphone.

10. A telemetry enabled flying disc system comprising:
a flying disc comprising an electronics package mounted to the flying disc, the electronics package comprising at least one processor, at least one memory, at least one sensor, and a communications system, wherein the telemetry enabled flying disc system is configured to store and execute instructions stored in the at least one memory that cause the at least one processor to:
establish a wireless connection between the communications system and a computing device;
transmit, via the wireless connection, sensor data from the at least one sensor to an application operating on the computing device, wherein transmitting the sensor data causes the application to analyze the sensor data to identify a release point of a throw of the flying disc; and
cause a display of the computing device to display a user interface depicting at least one launch parameter of the throw, wherein the at least one launch parameter is calculated using sensor data collected over a predetermined period after the release point.

11. The telemetry enabled flying disc system of claim 10 wherein the telemetry enabled flying disc is configured to store and execute instructions stored in the at least one memory that cause the at least one processor to:
cause the user interface to display a flight path of the throw, wherein the flight path is simulated based upon the at least one launch parameter of the throw.

12. The telemetry enabled flying disc system of claim 10 wherein the telemetry enabled flying disc is configured to store and execute instructions stored in the at least one memory that cause the at least one processor to:
cause the user interface to display a pre-launch path of the flying disc.

13. The telemetry enabled flying disc system of claim 11 wherein the user interface comprises an animation depicting the flight path of the throw.

14. The telemetry enabled flying disc system of claim 11, wherein the flight path is displayed in a two-dimensional or a three-dimensional view.

15. The telemetry enabled flying disc system of claim 11 wherein the telemetry enabled flying disc is configured to store and execute instructions stored in the at least one memory that cause the at least one processor to:
cause the user interface to display an option to adjust the at least one launch parameter of the throw; and
cause the user interface to display a modified flight path based upon the adjusted launch parameter.

16. The telemetry enabled flying disc system of claim 10 wherein the release point is determined by identifying a rotation of the flying disc by analyzing the sensor data.

17. The telemetry enabled flying disc system of claim 10 wherein the predetermined period is a range of about 10-20 milliseconds.

18. The telemetry enabled flying disc system of claim 10 wherein the at least one sensor is one of an accelerometer, a gyroscope, a magnetometer, a barometer, a camera, a timer, a radar device, or a microphone.

19. The telemetry enabled flying disc system of claim 10 wherein the telemetry enabled flying disc is configured to store and execute instructions stored in the at least one memory that cause the at least one processor to:
determine the at least one sensor is idle for a predetermined amount of time; and
place the electronics package into a low power mode.

20. A telemetry enabled flying disc system comprising:
a flying disc comprising an electronics package mounted to the flying disc, the electronics package comprising at least one processor, at least one memory, at least one sensor, and a communications system, wherein the telemetry enabled flying disc system is configured to store and execute instructions stored in the at least one memory that cause the at least one processor to:
detect movement of the flying disc indicative of a throw;
collect sensor data from the at least one sensor;
transmit, via a wireless connection, sensor data from the at least one sensor to an application operating on a computing device, wherein transmitting the sensor data causes the application to analyze the data to identify a release point of a throw of the flying disc;
cause a display of the computing device to display a user interface depicting at least one launch parameter of the throw, wherein the at least one launch parameter is calculated using sensor data collected over a predetermined period after the release point; and
cause the user interface to display a simulated flight path of the throw, wherein the simulated flight path is simulated based upon the at least one launch parameter of the throw.
